(19) United States
(12) Patent Application Publication
(10) Pub. No.: US 2003/0093774 A1
(43) Pub. Date: May 15, 2003

(54) State-specific variants of translated code under emulation

(76) Inventor: Ronald Hilton, San Francisco, CA (US)

Correspondence Address: FLIESLER DUBB MEYER & LOVEJOY, LLP, FOUR EMBARCADERO CENTER, SUITE 400, SAN FRANCISCO, CA, 94111, US

(21) Appl. No.: 09/992,120

(22) Filed: Nov. 14, 2001

(51) Int. Cl. G06F 9/45; G06F 15/00

(52) U.S. Cl. 717/138; 712/41

(57) ABSTRACT

Emulation of a guest computer architecture on a host system of another computer architecture. The guest computer architecture has programs composed of legacy instructions. To perform the emulation of the legacy instructions on the host system, the legacy instructions are accessed in the host system. Each particular legacy instruction is translated into one or more translated instructions for emulating the particular legacy instruction. State information is provided for determining a program execution mode for the legacy instructions. For each particular legacy instruction, a query is made to determine if translated instructions for execution mode remain stored as a result of a prior translation. If not stored, the legacy instruction is translated and the translated instructions are stored with the state information. If the translated instructions for the desired translation mode are already stored, emulation continues without need for further translation.

### BACKGROUND OF THE INVENTION

The present invention relates to computer systems and particularly to emulation of one computer architecture (the “guest”) via software on the hardware platform of another computer architecture (the “host”).

In typical computer architectures, computer source code is compiled/assembled (at compile/assembly time) into executable object code. The executable object code is executed at execution time on the hardware under control of the operating system. In order for computer source code written for a native architecture to run as a “guest” on a different architecture called a “host” architecture, the host architecture employs an emulator. The emulator emulates the native architecture while actually executing as a guest on the host architecture.

Various methods have been employed for emulating a guest computer architecture via software on the hardware platform of a host computer architecture. The categories of emulation are static emulation or dynamic emulation. In static emulation, the emulation is performed prior to run-time and in dynamic emulation, the emulation is performed at run-time.

One type of static emulation system employs object code translation. The native object code that is compiled/assembled for a native system becomes the guest object code on a host system. The guest object code is translated in a manner that is similar to the way that original source code is compiled/assembled into the object code for the native system. In the emulation case, however, rather than starting with the original source code, the emulation starts with the previously compiled/assembled object code as prepared for the native system. The guest object code (the native object code on the host system) is passed through an emulator to form the translated object code. The translated object code is suitable for execution directly by the host system. Essentially, static emulation is a method of recompiling the native object code without using the original source code. The advantage of such static emulation is that the resulting translated object code can be optimized in much the same way that native object code is optimized when native object code is compiled/assembled from original source code. Unfortunately, it is not always possible to glean all the necessary information statically from the native object code alone that was available when the original source code was compiled/assembled from original source code.

Another method of static emulation is Application Programming Interface (API) mapping. This method of static emulation only applies to operating system code in which the API calls of the guest operating system are mapped to a host call or set of host calls that perform the equivalent function on the host system. The API mapping has a performance advantage since the host operating system software has been optimized for the host system. However, if the native and host systems are too dissimilar, then the desired mapping may not always be possible. Nevertheless, API mapping is a useful method for providing some degree of equivalent operating system functionality when used in conjunction with other forms of static or dynamic emulation.

Dynamic emulation is performed during run time. The main advantage of dynamic emulation is greater transparency to the user in that no pre-processing need be invoked by the user as is required for static emulation. A simple type of dynamic emulation uses an interpreter which fetches, parses, and decodes each guest instruction and responsively executes a routine to carry out the equivalent functions on the host system. The main disadvantage of an interpreter is one of low performance because of the significant overhead involved in processing every guest instruction each time it is executed. To mitigate the disadvantage of that overhead, a more advanced method of dynamic emulation sometimes called “JIT” (just-in-time) translation is employed.

In JIT dynamic emulation, the native object code is translated (similar to the static method), cached, and executed in piecemeal fashion, a small portion at a time. By translating only a small portion of guest object code that is likely to be executed next, the translation is performed in real time, essentially concurrently with the execution of the translated code. The translated code is cached (that is, is saved) to permit subsequent re-use without the need for re-translation. The initial translation overhead is therefore amortized over time, allowing the overall performance to approach that of static object code translation, especially within the most frequently used portions of the code. By using additional information regarding program behavior that can be gleaned at run-time, it is possible to optimize the translated code to obtain performance beyond that achievable with static translation alone.

Emulation frequently is used when a CISC architecture is emulated on a RISC architecture. The legacy code of the program from the CISC architecture is processed to obtain the translated code for the translated program in the RISC architecture. The program behavior in any computer architecture is not only a function of the code being executed, but also depends on various modes of operation that perform different functions which may be enabled or disabled at the time of execution. Mere inspection of the code itself does not reveal whether such modes of operation are being invoked. Therefore, the translation process is hampered and impacted by when only conventional instruction by instruction translation is employed.

In order to take advantage of dynamic emulation, there is a need for improved dynamic emulators and processes that help achieve the objectives of improved computer system operation, particularly in the processing different modes of operation not explicitly detectable by the legacy code being translated and emulated.

### SUMMARY

The present invention emulates a guest computer architecture on a host system of another computer architecture. The guest computer architecture has programs composed of legacy instructions. To perform the emulation of the legacy instructions on the host system, the legacy instructions are accessed in the host system. Each legacy instruction is translated into one or more translated instructions that are executed to emulate the legacy instruction. State information is provided for determining a program execution mode for emulating the legacy instructions. For each legacy instruction, a query is made to determine if translated instructions, for execution in a particular mode, remain stored as a result of a prior translation of the legacy instructions. If translated instructions are not stored, the legacy instruction is translated and the translated instructions are stored together with the state information that determines the mode of execution. If the translated instructions for the desired translation mode are already stored, emulation continues without need for further translation.

In a typical embodiment, the legacy instructions are for a legacy system having a S/390 architecture and the legacy instructions are object code instructions compiled/assembled for the S/390 system and the translated instructions are for execution in a RISC architecture.

The foregoing and other objects, features and advantages of the invention will be apparent from the following detailed description in conjunction with the drawings.

### BRIEF DESCRIPTION OF THE DRAWINGS

FIG. 1 depicts a block diagram of a complex of computer systems including a native computer system and a number of computer systems for emulating the native computer system.

FIG. 2 depicts a block diagram of one emulator in the complex of FIG. 1 for emulating the native computer system of FIG. 1.

FIG. 3 depicts an example of one type of dynamic emulation in the FIG. 1 complex.

FIG. 4 depicts an example of improved dynamic emulation based upon storing program execution information along with translated RISC instructions.

### DETAILED DESCRIPTION

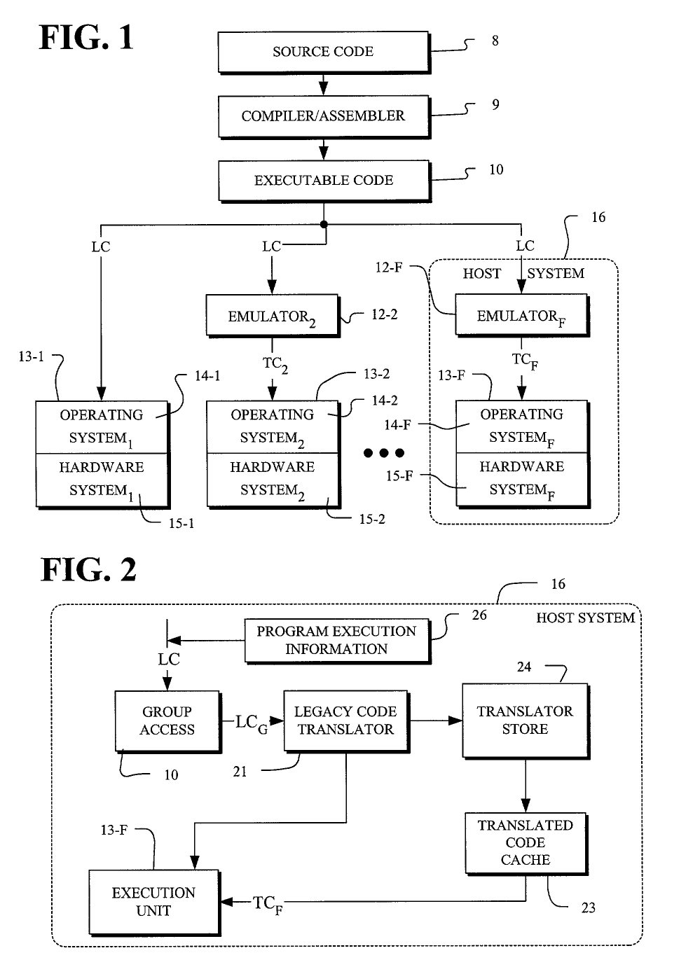

In FIG. 1, a complex of computer systems 13, including computer systems 13-1, 13-2, . . . , 13-F, is presented where the target computer systems 13-2, . . . , 13-F use translated code for emulating the native computer system 13-1. The computer systems 13-1, 13-2, . . . , 13-F are shown in a complex, each receiving the same executable codes. Typically, each of the computer systems 13-1, 13-2, . . . , 13-F is a stand-alone system and not in the same complex. The computer systems 13-1, 13-2, . . . , 13-F are organized as having a operating systems 14-1, 14-2, . . . , 14-F, respectively, and having hardware systems 15-1, 15-2, . . . , 15-F, respectively. In FIG. 1, the host system 16, in a typical embodiment, is a stand-alone system which receives executable legacy code 10 as an input.

For the computer systems 13 of FIG. 1, source code 8, programmed in a convenient language, represents many application and other programs that collectively constitute a large investment in time and knowledge for owners of native computer systems. The native system 13-1 has available well-perfected compilers/assemblers 9 for forming native executable code 11 (legacy code) that efficiently executes application and other programs on the native system 13-1. For the computer systems 13-2, . . . , 13-F, however, well-perfected compilers/assemblers may not be available or, even if available, the source code 8 may not always be available. In order to help preserve the investment in the application and other programs of the native computer system, emulators are employed to execute the executable legacy code on one or more of the target computer systems 13-2, . . . , 13-F. Typically, the target computer systems 13-2, . . . , 13-F are new computer systems that have a different architecture. The objective is to preserve the investment in the application and other programs of the native architecture by enabling them to execute by emulation on the target computer systems.

In FIG. 1, the native executable code 10 is used directly in the computer system 13-1 according to the native architecture which includes a native operating system 14-1 and a native hardware system 15-1. Also, the native executable code 10 is processed by the emulator 12-2 to produce translated code, TC₂, for execution by the target system 13-2 according to an architecture different from the native architecture and which includes an operating system 14-2 and a hardware system 15-2. Similarly, the native executable code 10 is processed by the emulator 12-F to produce translated code, TC_{F}, for execution by the target system 13-F according to an architecture different from the native architecture and which includes an operating system 14-F and a hardware system 15-F.

In FIG. 2, further details of the host system 16 of FIG. 1 are shown. The group access unit accesses legacy code (LC) and presents the legacy code in groups (LC_{G}) to a legacy code translator 21. The legacy code translator 21 stores detailed information about the translation in translation store 24. The legacy code translator 21 also stores the executable blocks of host code in a translated code (TC) cache 23. Legacy features and modes of operation are defined by Program Execution Information 26.

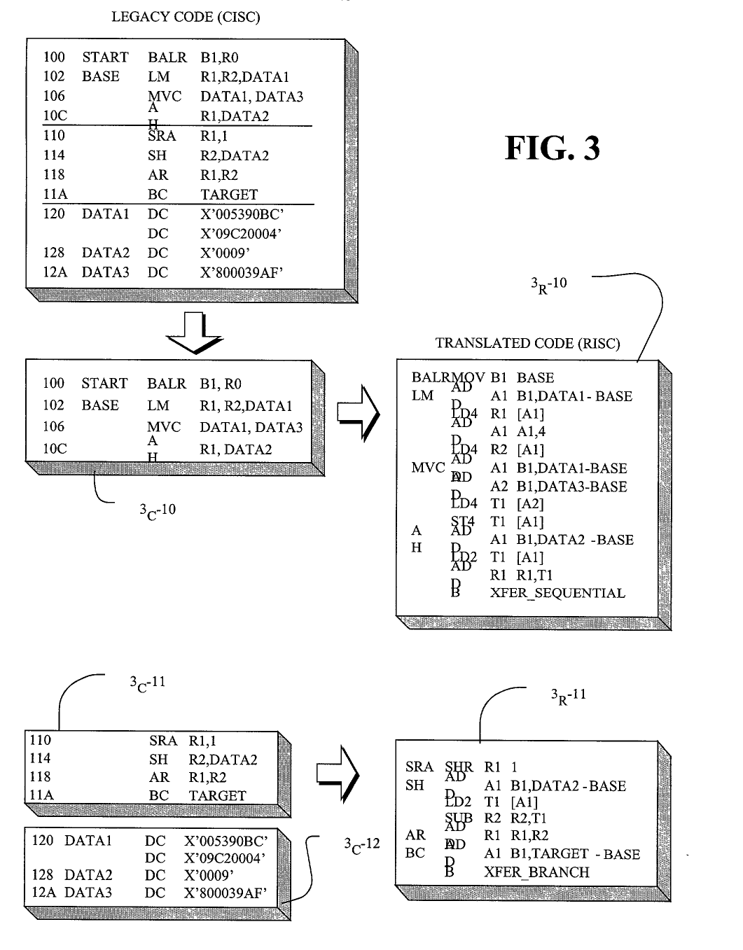

A typical example of a known emulation is illustrated in FIG. 3. In this example, legacy code is being translated to translated code where the legacy code is complex instruction set code (CISC) for a CISC architecture computer system and the translated code is reduced instruction set code (RISC) for a RISC architecture computer system. In the FIG. 3 example, the legacy code is for the S/390 architecture. In the example, the code has been simplified for purposes of clarity of explanation. The same principles apply to translations from any given architecture to any other architecture.

In FIG. 3, a typical example of CISC legacy code consists of eight S/390 instructions (with hexadecimal instruction byte addresses 100, 102, 106, 10C, 110, 114, 118 and 11A) followed by 14 bytes of operand data (with hexadecimal byte addresses 120, 128, 12A) for a total of 44 bytes. The first step in the translation is to access the legacy code blocks. In the example, there are three 16-byte aligned blocks (a first block at addresses 100, 102, 106, 10C; a second block at addresses 110, 114, 118, 11A; and a third block at addresses 120, 128, 12A). Each CISC block is translated into a block of corresponding RISC code by translating each CISC instruction in a block in order. One or more RISC instructions are required to perform the equivalent function of each CISC instruction depending on the degree of complexity of each CISC instruction.

In the example of FIG. 3, the CISC instructions BALR, SRA, and AR each require only one RISC instruction, the CISC instructions AH and SH require three RISC instructions, and the CISC instructions LM and MVC require four RISC instructions. The third CISC block (with addresses 120, 128, 12A) consists solely of operand data and does not require translation. The blocks of RISC translated code emitted from the emulation are executed by the target computer system 13-2 of FIG. 1. In typical translation operation, a transfer routine is called at the end of each RISC block to locate the next block. At the end of the first block, XFER_SEQUENTIAL is called to look up the cache location of the RISC block corresponding to the next sequential CISC address (110 in the example). The second block ends in a branch (BC), and therefore calls XFER_TARGET to perform the analogous look-up function for the CISC branch target address.

The FIG. 3 example includes S/390 CISC instructions organized in CISC blocks including, for example, CISC blocks 3_{C}-10 and 3_{C}-11. For a typical translation of the FIG. 3 CISC blocks as shown in FIG. 3, a one-to-one correspondence exists between CISC blocks and translated RISC blocks. The translated RISC blocks 3_{R}-10 and 3_{R}-11 correspond to the CISC blocks 3_{C}-10 and 3_{C}-11, respectively. After translation, the RISC blocks 3_{R}-10 and 3_{R}-11 are held in the cache memory designated in FIG.3 as TRANSLATED CODE (RISC). Storage in the cache memory permits the translated RISC blocks 3_{R}-10 and 3_{R}-11 to be associated with the CISC blocks 3_{C}-10 and 3_{C}-11 from which they are translated.

The CISC blocks 3_{C}-10 and 3_{C}-11 are understood to be executed as a function of various features and modes of operation available in the legacy system. These features and modes are defined by Program Execution Information. In the S/390 architecture, Program Execution Information is stored, for example, in the architecturally defined Program Status Word (PSW) and Control Registers. Mere inspection of the CISC code in the FIG. 3 translation example does not reveal all of the modes of execution that are possibly enabled.

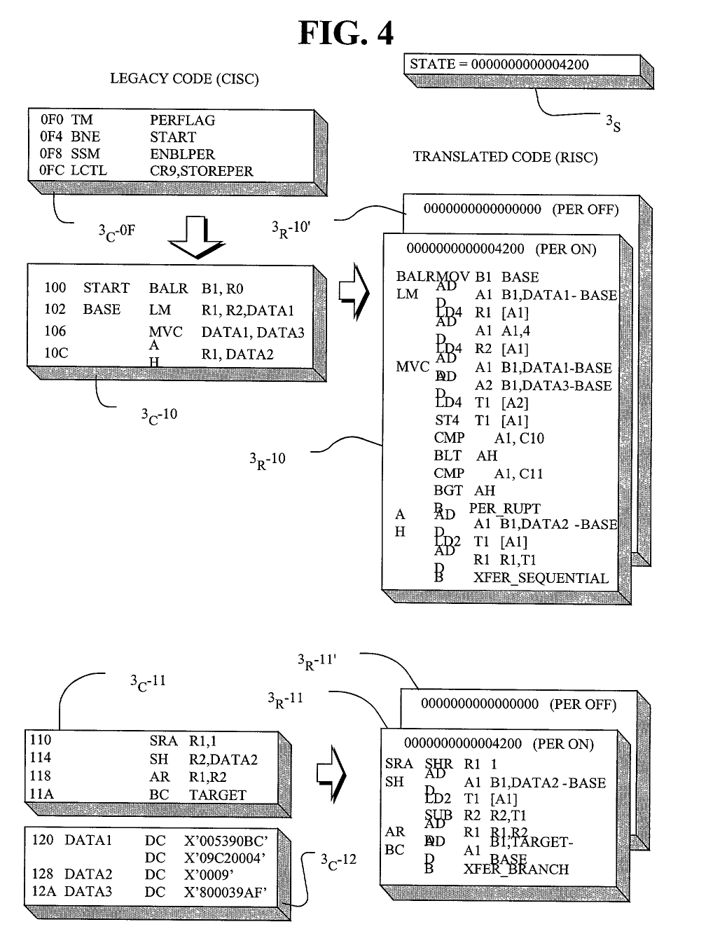

FIG. 4 depicts an example of improved dynamic emulation based upon storing program execution information along with translated RISC instructions in cache locations so as to enable execution of the translated RISC code to proceed with selected modes enabled or disabled.

The FIG. 4 example includes the S/390 CISC instructions of FIG. 3 organized in CISC blocks including the CISC blocks 3_{C}-10 and 3_{C}-11. The CISC blocks 3_{C}-10 and 3_{C}-11 are defined for execution with selected modes enabled or disabled. To include details for these selected modes, the program execution information 27 in FIG. 2 tracks the possible modes of the legacy system and as might be enabled or disabled by a CISC code block 3_{C}-0F executed before the CISC blocks 3_{C}-10 and 3_{C}-11. The legacy code translator 21 based upon the program execution information captured in CISC code block 3_{C} operates to insert program execution information into the translator store 24 and cache 23.

In the FIG. 4 example of S/390 CISC instructions of FIG. 3, one example of program execution information is the Program Event Recorder (PER) that is either in the enabled or disabled mode. Mere inspection of the CISC code in the FIG. 3 translation example does not reveal whether the Program Event Recorder (PER) is enabled or disabled. In the S/390 architecture, a determination of whether the Program Event Recorder (PER) is enabled requires examination of the Program Status Word (PSW) and Control Register 9. This inspection is performed by the Program Execution Information 27 process which operates to track the execution of CISC code block 3_{C}-0F before the CISC blocks 3_{C}-10 and 3_{C}-11.

The FIG. 4 operation for processing in the PER enabled mode for the FIG. 3 CISC translation is as follows. The CISC code of FIG. 4 is the same as the CISC code in FIG. 3 except that it is now preceded by four additional instructions in CISC block 3_{C}-0F.

In CISC block 3C-0F, the TM CISC instruction at 0F0 checks a flag in memory, PERFLAG, to determine whether PER is to be enabled. If not, the BNE instruction at 0F4 branches directly to START in CISC block 3_{C}-10. Otherwise, the SSM instruction at 0F8 sets the PER bit, ENBLPER, in the PSW and the LCTL instruction 0FC sets the store PER bit, STOREPER, in the CR9 control register thereby specifying that all store addresses be matched against the address range indicated in control registers CR10 and CR11.

In the embodiment of FIG. 4, the values of key control bits, such as those controlling PER, are assembled together by The Program Execution Information 27 process into a STATE word 3_{S}, as shown at the top of FIG. 4. In a first translation of the CISC code of FIG. 3, in the PER Off mode (0000000000000000 PER Off), the resulting first version of the translation proceeds as described in connection with FIG. 3. In FIG. 4, the first version of the FIG. 3 translation additionally includes storage at the time of translation in each of the RISC blocks 3_{R}-10′ and 3_{R}-11′ of the Per Off value of the STATE word (0000000000000000). The Per Off value of the STATE word is shown in FIG. 4 at the top of each of the blocks 3_{R}-10′ and 3_{R}-11′.

In a second translation of the CISC code of FIG. 3, in the PER On mode (0000000000004200 PER On), the resulting second translation is the same as in connection with FIG. 3 except that a PERFLAG is on and causes the PER functions to be performed. With the PERFLAG on, the PER control bits in the PSW and the CR9 are set and these are reflected in the non-zero contents of the STATE word. The contents of the STATE word (0000000000004200) are saved in each of the blocks 3_{R}-10 and 3_{R}-11 of the second translated version of RISC code at the time of translation, as shown in FIG. 4 at the top of each of the blocks 3_{R}-10 and 3_{R}-11.

As can be seen by comparing the translation versions in FIG. 4, the STATE word (0000000000000000) for the first translation version in blocks 3_{R}-10′ and 3_{R}-11′ differs from the STATE word (0000000000004200) for the second translation version in blocks 3_{R}-10 and 3_{R}-11.

If at any time a translation of the FIG. 3 CISC code is called for, a query is made to determine if a translation already made is available from storage. If a translation is not available, then the translation occurs and is stored as described. If a translation is available, then the translation STATE word is checked to see if a match occurs between the requested mode and a stored mode. If a match occurs, then the stored translation is one that has the desired functions and modes of operation. If a match of the STATE word does not occur, then the stored translation is not one for the desired mode of operation and hence a retranslation occurs for the desired mode.

In the example described in connection with FIG. 4, if a third request is made for the FIG. 3 translation and either or both the first translation and the second translation remain stored, then the appropriate translation (PER On or PER Off) is selected and no need for further translation is required.

The PER Off first translation stored in RISC blocks 3_{R}-10′ and 3_{R}-11′ is not discarded when a PER On translation is made because it is possible that the same first translated code will be executed again in the future with PER again turned off. In that case, the STATE word will match that of the first translation which is then re-used. Note that for the particular example given, the translation of the second block 3_{R}-11′ is actually the same whether the PER function is on or off, because it contains no stores, and is in that sense redundant. For that reason, the embodiment described is best suited for those architectural features that are either infrequently used or are fairly static in terms of their default setting.

Note that additional RISC code has been generated for executing the MVC instruction for the PER On mode. The additional RISC code instructions (RISC instructions CMP, BLT, CMP and BGT) function to check whether the store address A1 lies within the specified PER range. If it does, then the PER_RUPT routine is called to emulate the PER program interrupt in accord with the S/390 architecture.

An embodiment was described, as a representative example, in connection with the PER mode of operation. The present invention applies to other modes of operation.

For example, the following state-specific variants have modes specified in the Program Status Word (PSW): Dynamic Address Translation (DAT) mode (i.e. virtual vs. real addressing); Address Space (AS) mode (i.e. primary vs. home mode for instruction fetching); Addressing mode (i.e. 24- vs. 31-bit addressing); Problem vs. Supervisor state mode; Storage protection key mode that determines what storage protection is in effect; and Program Mask mode (i.e. bits controlling how arithmetic exceptions are handled).

In addition, various modes are determined by bits within the Control Registers which affect how various instructions operate including, for example: Extraction Authority Control; Set System Mask Suppression Control; and Secondary Space Control.

Another example of a mode occurs for the Execute Mask which affects how the subject instruction of an Execute operates. There are also non-architectural features that affect instruction emulation, such as whether or not various emulator debug facilities are enabled. There are other mode bits as well that only affect instructions that are infrequently used, and they are therefore handled at execution time with no appreciable impact on performance.

While the invention has been particularly shown and described with reference to preferred embodiments thereof it will be understood by those skilled in the art that various changes in form and details may be made therein without departing from the scope of the invention.

1. (Original) A method for dynamic emulation of legacy instructions of a legacy program comprising:
providing state information for determining a program execution mode for emulating said legacy instructions,
accessing said legacy instructions and said state information,
for each particular legacy instruction,
querying to determine if one or more particular translated instructions for said execution mode are stored as a result of translating said legacy instruction for said execution mode, and
if not translated for said execution mode,
translating the particular legacy instruction into one or more particular translated instructions for emulating the particular legacy instruction for said execution mode,
storing said one or more particular translated instructions with said state information, and
if translated for said execution mode, continuing without additional translating,
accessing said one or more particular translated instructions for emulating said legacy instructions for said execution mode.

2. (Original) The method of claim 1 wherein said storing of the one or more particular translated instructions is in one or more particular translated blocks and said state information is stored in each of said particular translated blocks.

3. (Original) The method of claim 1 wherein said legacy instructions are for a legacy system having a S/390 architecture.

4. (Original) The method of claim 1 wherein said legacy instructions are object code instructions compiled/assembled for a legacy architecture.

5. (Original) The method of claim 1 wherein said translated instructions are for execution in a RISC architecture.

6. (Original) A method for dynamic emulation of legacy instructions, where the legacy instructions are compiled/assembled into object code form for a native architecture, where the legacy instructions are executed as guests in the host architecture, where the legacy instructions are translated to translated instructions in the host architecture and the translated instructions are executed in the host architecture concurrently with the translation of the legacy instructions in the host architecture, comprising:
providing state information for determining a program execution mode for emulating said legacy instructions,
accessing said legacy instructions and said state information as guests in the host architecture,
for each particular legacy instruction,
querying to determine if one or more particular translated instructions for said execution mode are stored as a result of translating said legacy instruction for said execution mode, and
if not translated for said execution mode,
translating the particular legacy instruction into one or more particular translated instructions for emulating the particular legacy instruction for said execution mode,
storing said one or more particular translated instructions with said state information, and
if translated for said execution mode, continuing without additional translating,
accessing said one or more particular translated instructions for emulating said legacy instructions for said execution mode as a guest in said host architecture.
